(19) United States
(12) Patent Application Publication
(10) Pub. No.: US 2012/0299812 A1
(43) Pub. Date: Nov. 29, 2012

(54) APPARATUS AND METHOD FOR CONTROLLING DATA OF EXTERNAL DEVICE IN PORTABLE TERMINAL

(75) Inventor: Se-Jin PARK, Gyeonggi-do (KR)

(73) Assignee: SAMSUNG ELECTRONICS CO., LTD., Gyeonggi-Do (KR)

(21) Appl. No.: 13/309,811

(22) Filed: Dec. 2, 2011

(30) Foreign Application Priority Data
May 23, 2011 (KR) 10-2011-0048408

(51) Int. Cl. G09G 5/00

(52) U.S. Cl. 345/156

(57) ABSTRACT

An apparatus and a method operate in a portable terminal to control data of an external device, for example, remotely controlling data output from the external device connected to the portable terminal without directly manipulating the portable terminal. The apparatus includes a camera for receiving an image of a hand and a controller for controlling data being output from the external device according to a gesture of the hand determined to be equivalent to a hand gesture image received through the camera while the controller is connected to and outputs data to the external device.

### CLAIM OF PRIORITY

This application claims priority under 35 U.S.C. §119 to a Korean Patent Application entitled “Apparatus and Method for Controlling Data of External Device in Portable Terminal,” filed in the Korean Intellectual Property Office on May 23, 2011 and assigned Serial No. 10-2011-0048408, the contents of which are incorporated herein by reference.

### BACKGROUND OF THE INVENTION

1. Field of the Invention

The present invention relates broadly to an apparatus and method capable of controlling data in an external device using a portable terminal, and more particularly to an apparatus and a method for controlling data in an external device using a portable terminal by which data output from an external device connected to the portable terminal is remotely controlled without directly manipulating the portable terminal.

2. Description of the Related Art

A typical portable terminal may be connected to an external device and output data from the portable terminal to the connected external device.

When the portable terminal is connected to the external device through a HDMI (High Definition Multimedia Interface) cable, supporting only an HDMI output, a user is compelled to directly manipulate the portable terminal to perform operations including a screen change, the change of a reproduced file, and web browsing for data to be output from (i.e., displayed by) the external device. Such required direct manipulation of the portable terminal is inconvenient.

### SUMMARY OF THE INVENTION

The present invention overcomes the above-mentioned shortcomings.

In one aspect, the present invention provides an apparatus and a method for controlling data in an external device in a portable terminal, whereby data being output from the external device connected to the portable terminal is remotely controlled without directly manipulating the portable terminal.

In an embodiment, the invention provides apparatus for controlling data of an external device in a portable terminal. The apparatus includes a camera for receiving an image of a hand and a controller for controlling data as it is output from/by the external device according to a gesture of the hand. The hand gesture upon which the control is based is determined to be equivalent to an image of the hand (or hand gesture) received through the camera while the controller is connected to the external device and controls output of data to the external device (for display/output).

In another embodiment, the invention provides a method for controlling data of an external device, the method implemented in a portable terminal. The method includes outputting data to the external device connected to the portable terminal and performing a function for controlling the data according to a gesture of a hand determined to be equivalent to an image of the hand (or hand gesture) received through a camera.

In another embodiment, the invention provides a portable terminal for controlling data of an external device. The portable terminal includes a camera for receiving an image of a hand and a controller for controlling data output from the external device according to a gesture of the hand determined from the image of the hand received while the controller is connected to and outputs data to the external device.

### BRIEF DESCRIPTION OF THE DRAWINGS

The above and other exemplary features, aspects, and advantages of the present invention will be more apparent from the following detailed description taken in conjunction with the accompanying drawings, in which:

FIG. 1 is a view for explaining an operation for controlling data of an external device in a portable terminal according to an embodiment of the invention;

FIG. 2 is a block diagram illustrating a configuration of a portable terminal according to an embodiment of the invention; and

FIG. 3 is a flowchart showing a process for controlling data of an external device in a portable terminal according to an embodiment of the invention.

### DETAILED DESCRIPTION

Hereinafter, exemplary embodiments of the present invention will be described in detail with reference to the accompanying drawings. It should be noted that, in the accompanying drawings, the same configuration elements are designated by the same reference numerals throughout. For that matter, while an external device, for example, is described as a television (TV) in an exemplary embodiment of the invention, the invention is not limited thereto. That is, the external device may be implemented as any known external device which may be connected to the portable terminal and output data received from the portable terminal.

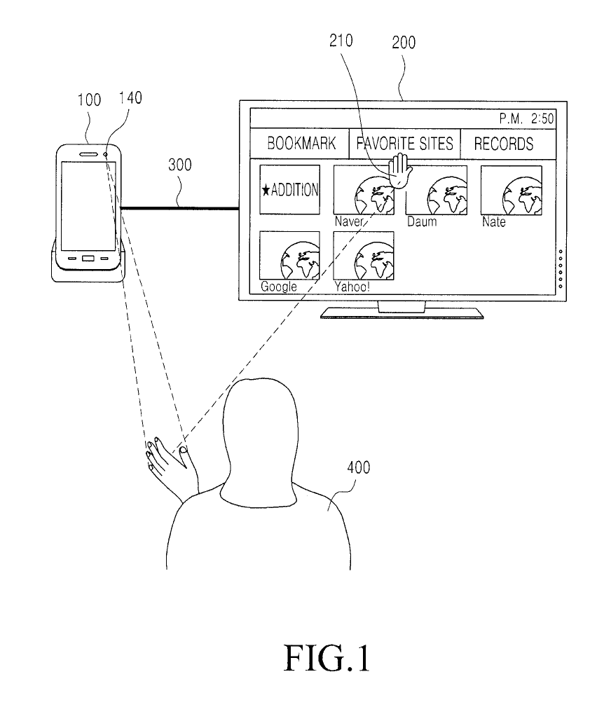

FIG. 1 is a view for explaining an operation for controlling data of an external device in a portable terminal according to an embodiment of the invention.

Referring to FIG. 1, a portable terminal 100 mounted in a cradle is connected to a TV 200 through a connection unit 300, enabling output of data to the TV 200. The TV 200 receives data from the portable terminal 100 connected thereto through the connection unit 300, and then outputs the received data. The connection unit 300 may be a HDMI cable, but is not limited thereto.

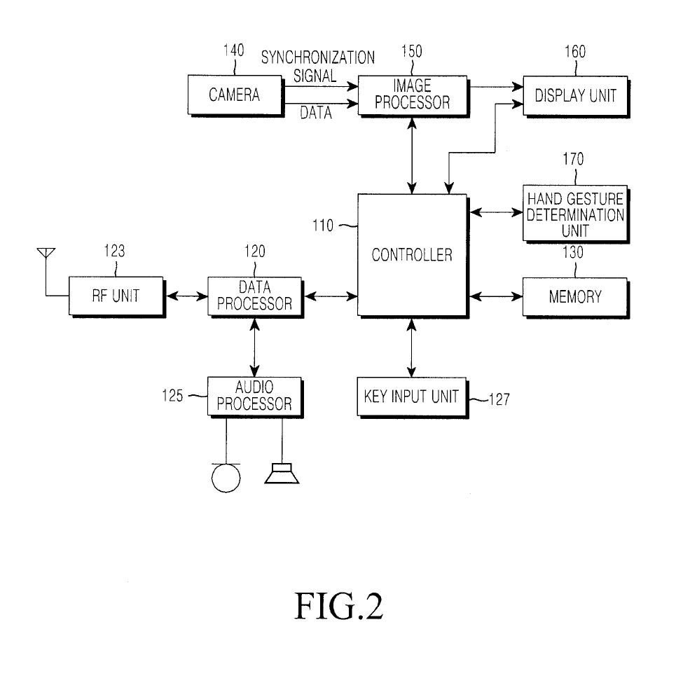

While the portable terminal 100 outputs data to the TV 200, it determines a type of hand gesture of a user 400 based on a hand image of the user received through a camera included in the portable terminal 100. Based on the type of hand gesture determined, the portable terminal performs a function for controlling data being output to the TV 200. The configuration of the portable terminal 100 will now be described with reference to FIG. 2.

Referring to FIG. 2, an RF unit 123 performs a wireless communication function of the portable terminal. The RF unit 123 includes an RF transmitter for upconverting the frequency of a signal to be transmitted and then amplifying the frequency-upconverted signal. The RF unit also includes an RF receiver for low-noise amplifying a received signal and then downconverting the frequency of the low-noise amplified signal, etc. A data processor 120 includes a transmitter for encoding and modulating a signal to be transmitted, a receiver for demodulating and decoding a signal received by the RF unit 123, etc.

Data processor 120 preferably includes a modem (modulator/demodulator) and a codec (coder/decoder), where the codec includes a data codec for processing packet data and the like, and an audio codec for processing audio signals including voice and the like. The audio processor 125 reproduces a received audio signal, which has been output from the audio codec of the data processor 120, or transmits an audio signal to be transmitted to the audio codec of the data processor 120. Audio signals to be transmitted are generated by a microphone, as shown.

A key input unit 127 includes keys for inputting numbers and text information and function keys for setting various functions. A memory 130 includes a program memory and a data memory. The program memory stores programs for controlling a general operation of the portable terminal and a program by which a gesture of the user's hand can control data in a virtual control mode, which data are output to the TV. Memory 130 also stores types of hand gestures and types of control functions corresponding to the types of the hand gestures.

Controller 110 controls an overall operation of the portable terminal.

According to an embodiment, as the camera 140 operates while the portable terminal 100 outputs data to the TV 200, the controller 110 changes the portable terminal 100 to a preview mode. The controller then generates and outputs a hand-shaped frame in the center of a display unit of the TV 200.

Also, the controller 110 recognizes an image of the user's hand received through the camera 140 in the preview mode. When the controller 110 detects the recognized position of the user's hand at the hand-shaped frame 210, it changes the portable terminal 100 to the virtual control mode.

Further, the controller 110 transmits the image of the user's hand received through the camera 140 to a hand gesture determination unit 170 in the virtual control mode. When receiving a type of hand gesture corresponding to the hand image from the hand gesture determination unit 170, the controller 110 extracts a type of a control function corresponding to the type of the hand gesture in the memory 130.

Then, the controller 110 controls the data output/transmitted to the TV 200 in accordance with the extracted type of the control function. Concurrently, in the virtual control mode, the controller 110 displays a hand-shaped icon capable of displaying the execution of a function for controlling data output to the TV 200.

The types of the control functions include all functions for controlling data that is output to the TV 200, such as a screen change, data selection, dragging, and the like.

The camera 140 includes a camera sensor for capturing image data and converting the captured light signal to an electrical signal, and a signal processor for converting the analog image signal captured by the camera sensor to digital data.

Preferably, the camera sensor is a CCD (Charge-Coupled Device) sensor or a CMOS (Complementary Metal-Oxide Semiconductor) sensor. The signal processor may be implemented by a DSP (Digital Signal Processor). For that matter, while the camera sensor and the signal processor may be implemented as one unit, they also may be implemented as separate elements.

If the portable terminal 100 is changed to a preview mode while it is connected to the TV 200, the camera 140 receives a received image of the user's hand in the preview mode.

The image processor 150 performs ISP (Image Signal Processing) on an image signal output from the camera 140, for display by a display unit 160. In this case, the term “ISP” refers to the execution of functions including a gamma correction, an interpolation, a spatial change, an image effect, an image scale, AWB (Auto White Balance), AE (Auto Exposure), AF (Auto Focus), etc. Therefore, the image processor 150 processes the image signal, which has been output from the camera 140, on a frame-by-frame basis, and outputs the frame image data in accordance with the requirements of the display unit 160, i.e., frame size.

Image processor 150 includes an image codec, and compresses the frame image data displayed by the display unit 160 in a set scheme, or restores the compressed frame image data to an original frame image data. In this case, the image codec is implemented using a JPEG (Joint Photographic Coding Experts Group) codec, an MPEG-4 (Moving Picture Experts Group-4) codec, a Wavelet codec, or the like. It is assumed that the image processor 150 includes an OSD (On-Screen Display) function. The image processor 150 output on-screen display data according to the size of a screen displayed under the control of the controller 110.

The hand gesture determination unit 170 determines a type of gesture of the user's hand recognized through the camera 140 in the virtual control mode and transmits a result of the determination to the controller 110. An operation for determining a type of gesture of the user's hand by the hand gesture determination unit 170 is a publicly-known technology. A description of an operation for determining a type of gesture of the user's hand is omitted, therefore.

The display unit 160 displays an image signal output from the image processor 150 on a screen thereof as well as the user data output from the controller 110. In this case, the display unit 160 may employ an LCD (Liquid Crystal Display), and thus may include an LCD controller, a memory capable of storing image data, an LCD display element, etc. When the LCD employs a touch screen, the display unit 160 operates as an input unit. At this time, the display unit 160 may display keys which are identical to those of the key input unit 127.

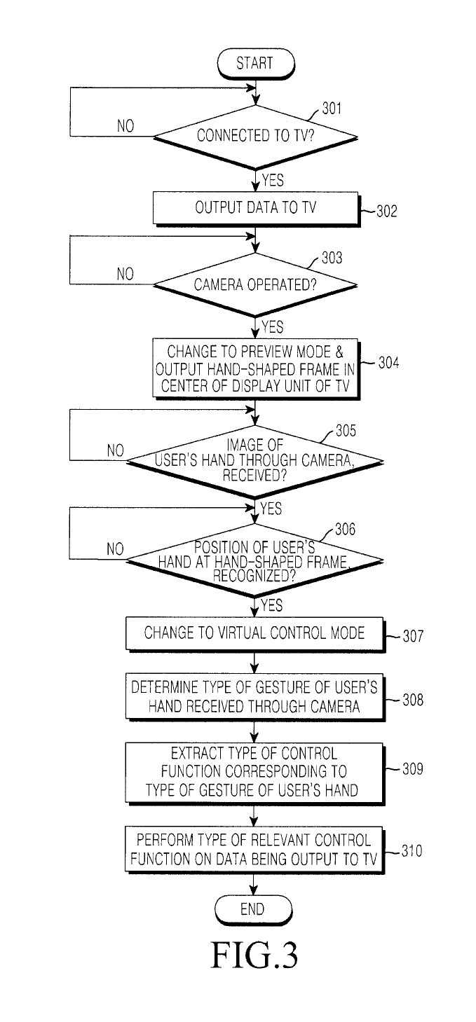

An operation in which the above portable terminal can control data being output from an external device now will be described in detail with reference to the flowchart of FIG. 3.

Referring to FIG. 3, when the portable terminal 100 is connected to the TV 200 through the connection unit 300, the controller 110 detects the connection in step 301. Process flow then proceeds to a process step 302, whereby data of the portable terminal 100 is output to the TV 200.

When the camera 140 operates, the controller 110 detects the operation of the camera 140 in step 303. Process flow then proceeds to step 304, whereby the controller 110 changes the portable terminal 100 to a preview mode and generates and outputs a hand-shaped frame 210 to the center of the display unit of the TV 200. The camera 140 may operate automatically or manually.

When a hand image of the user 400 is received through the camera 140 in the preview mode in step 304, the controller 110 detects the received hand image of the user 400 in step 305, and determines whether the hand position of the user 400 is recognized at the hand-shaped frame 210 which is being output by the display unit of the TV 200.

If the hand position of the user 400 is recognized at the hand-shaped frame 210, the controller 110 detects the recognized hand position of the user 400 in step 306. Process flow then proceeds to step 307, where the portable terminal 100 is changed to a virtual control mode capable of performing a control function according to a type of hand gesture of the user 400. At this time, in order to convey that the position of the user's hand coincides with the hand-shaped frame, and that same has been recognized (by the terminal), the color of a message display or the hand-shaped frame is changed.

An operation for determining whether the hand position of the user 400 is recognized at the hand-shaped frame 210 now will be described below. First, the controller 110 displays a first image of the user's hand received by the camera 140 in a predetermined area of the display unit of the TV 200. Thereafter, when a user's hand moves in order to cause his or her own hand to coincide with a hand-shaped frame displayed by the display unit of the TV 200, the controller 110 determines the movement position of an image of the user's hand received through the camera 140 while the user's hand moves with the position of a predetermined area, where the image of the user's hand is first displayed, as reference. The controller 110 thereby determines that the position of the image of the user's hand has been located at the hand-shaped frame 210.

Alternatively, the controller 110 automatically changes the portable terminal 100 to the virtual control mode when a predetermined time period elapses after the display unit of the TV 200 displays the hand-shaped frame 210.

Alternatively, the controller 110 simultaneously changes the portable terminal 100 to the virtual control mode when the portable terminal 100 is changed to a preview mode while outputting data to the TV 200.

Alternatively, the controller 110 changes the portable terminal 100 to the virtual control mode when a type of hand gesture is determined to be a command for changing to a virtual control mode in the preview mode while the portable terminal 100 outputs data to the TV 200.

Further, in the virtual control mode in step 307, the controller 110 notifies the change of the portable terminal 100 to the virtual control mode by displaying the hand-shaped icon on the display unit of the TV 200. Also, the controller 110 displays the execution of a function for controlling data being displayed by the display unit of the TV 200.

In the virtual control mode, the controller 110 proceeds to step 308, whereby it determines a type of hand gesture based on an image of the user's hand received through the camera 140.

In step 308, when receiving a hand image of the user 400 through the camera 140, the controller 110 transmits the received image of the user's hand to the hand gesture determination unit 170. The hand gesture determination unit thereafter determines a type of gesture of the received image of the user's hand. When the controller 110 has determined the type of gesture of the user's hand, it proceeds to step 309, whereby a type of a control function corresponding to the determined type of gesture of the user's hand is extracted from the memory 130.

Then, the controller 110 proceeds to step 310, whereby it performs the extracted type of the control function on data being output to the TV 200, and then outputs the data to the TV 200. For example, when the controller 110 has determined that a type of gesture of the user's hand is a function for controlling position movement, the portable terminal 100 outputs data resulting from the function of controlling position movement to the TV 200. The display unit of the TV 200 displays the hand-shaped icon which moves from data being displayed thereby to a predetermined position while the hand-shaped icon moves thereon in such a manner that it is matched to the function of controlling position movement.

Alternatively, when a type of gesture of the user's hand is the action of opening and closing his or her hand, the controller 110 determines that the type of gesture of the user's hand is a function for controlling selection. Then, the portable terminal 100 outputs result data corresponding to a selected position among multiple pieces of data to the TV 200. Therefore, the display unit of the TV 200 displays data resulting from data at a position selected by the hand-shaped icon.

Alternatively, when a type of gesture of the user's hand is movement in the state of closing his or her hand, the controller 110 determines that the type of gesture of the user's hand is a function for controlling a drag action. Then, the portable terminal 100 outputs data resulting from the function of controlling the drag action to the TV 200. Therefore, the display unit of the TV 200 may display the operation of the hand-shaped icon which moves to the relevant data while the hand-shaped icon moves thereon in such a manner that it is matched to the function of controlling the drag action.

As described above, the user 400 does not need to directly manipulate the portable terminal 100 in order to control data of the portable terminal 100, which is output to the TV 200. The user 400 can perform the operation of remotely controlling the data of the portable terminal 100 provided/output to the TV 200 using only the gesture of the user's hand.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although the specific exemplary embodiments, such as a portable terminal, have been shown and described above, various changes in form and details may be made in the embodiments without departing from the spirit and scope of the invention, which should be limited only by the appended claims and equivalents of the appended claims.

What is claimed is:

1. An apparatus for controlling data of an external device in a portable terminal, the apparatus comprising:
a camera for receiving an image of a hand; and
a controller for controlling data output from the external device according to a gesture of the hand determined from the image of the hand received while the controller is connected to and outputs data to the external device.

2. The apparatus according to claim 1, wherein the controller changes the portable terminal to a preview mode and displays a hand-shaped frame in a center of a display unit of the external device when the camera operates while the controller outputs data to the external device and wherein the controller changes the portable terminal to a virtual control mode capable of controlling data according to a type of the gesture of the hand when a position of the hand is recognized at the hand-shaped frame.

3. The apparatus according to claim 2, wherein the controller recognizes the image of the hand received through the camera in the preview mode and changes the portable terminal to the virtual control mode when the recognized position of the hand is recognized at the hand-shaped frame.

4. The apparatus according to claim 2, wherein the controller displays a hand-shaped icon representing execution of a function for controlling data output to the external device in the virtual control mode.

5. The apparatus according to claim 2, wherein the controller determines a type of the gesture of the hand based on the image of the hand received through the camera, extracts a type of a control function corresponding to the type of the gesture of the hand, and executes the control function on data being output from the external device in the virtual control mode.

6. The apparatus according to claim 1, further comprising a memory for storing types of the gestures of the hand and types of control functions corresponding to the types of the gestures.

7. The apparatus according to claim 1, further comprising a hand gesture determination unit for determining a type of the gesture of the hand based on the image of the hand received through the camera.

8. The apparatus according to claim 1, wherein the portable terminal is connected to the external device through a high definition multimedia interface (HDMI) cable.

9. A method operating in a controller of a portable terminal for controlling data of an external device, the method comprising:
outputting data to the external device connected to the portable terminal; and
performing a function for controlling the data output to the external device according to a gesture of a hand determined to be equivalent to a hand gesture image received through a camera.

10. The method as set forth in claim 9, wherein performing the function for controlling the data output to the external device comprises:
changing the portable terminal to a preview mode and displaying a hand-shaped frame in a center of a display unit of the external device when the camera operates as the data is output to the external device;
changing the portable terminal to a virtual control mode when a position of the hand is recognized at the hand-shaped frame;
determining a type of the gesture of the hand based on the image of the hand received through the camera and extracting a type of a control function corresponding to the type of the gesture determined in the virtual control mode; and
performing the extracted the control function type on data being output from the external device.

11. The method as set forth in claim 10, wherein changing of the portable terminal to the virtual control mode comprises:
recognizing the hand by the camera; and
determining whether the position of the recognized hand is located at the hand-shaped frame.

12. The method as set forth in claim 10, further comprising displaying a hand-shaped icon representing execution of a function for controlling data output to the external device in the virtual control mode.

13. The method as set forth in claim 9, further comprising connecting the portable terminal to the external device through a high definition multimedia interface (HDMI) cable.
